(19) United States
(12) Patent Application Publication
(10) Pub. No.: US 2008/0284547 A1
(43) Pub. Date: Nov. 20, 2008

(54) Magnetostrictive electrical switching device

(75) Inventors: Patrick Claeys, Darmstadt (DE); Joachim Becker, Schwetzingen (DE); Ralf Weber, Heidelberg (DE); Richard Kommert, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/153,147

(22) Filed: May 14, 2008

Related U.S. Application Data
(63) Continuation of application No. PCT/EP2005/012219, filed on Nov. 15, 2005.

(51) Int. Cl. H01H 55/00

(52) U.S. Cl. 335/3

(57) ABSTRACT

The disclosure proposes an electrical switching device having at least one contact point having at least one drive, which opens the contact point directly and/or via a switching mechanism with a latching point and which drive has an element having a predetermined shape, which element consists of a shape memory alloy, which changes its shape under the influence of an electromagnetic field and, in the process, opens or closes a contact point or double contact point or unlatches a switching mechanism.

### RELATED APPLICATION

This application claims priority as a continuation application under 35 U.S.C. §120 to PCT/EP2005/012219 filed as an International Application on 15 Nov. 2005 designating the U.S., the entire content of which is hereby incorporated by reference in its entirety.

### TECHNICAL FIELD

The disclosure relates to an electrical switching device with at least one contact point, which is opened by means of an actuator directly or via a switching mechanism with a latching point, the actuator opening the latching point and/or the contact point.

### BACKGROUND INFORMATION

Electrical switching devices in this sense are line circuit breakers, residual current circuit breakers, motor circuit breakers or the like and contactors.

In the case of line circuit breakers, a switching mechanism is provided which has a latching point, which, on the one hand, is unlatched by a thermal release, for example by a bimetallic strip or a strip of a shape memory alloy, with the result that the contact point is opened; the thermal release in this case trips in the event of the occurrence of an overcurrent. Since a line circuit breaker also needs to disconnect short circuits, an electromagnetic release is also provided, which has a coil, a magnet yoke, a magnet core and an armature; the armature strikes, possibly via a spindle or rod, the contact lever of the line circuit breaker and actuates the latching point via a coupling in the form of a slide, with the result that, once the contact lever has opened, the contact lever is held in the open position by the armature because the latching point is unlatched. Line circuit breakers have to perform their task on load or in the case of the occurrence of a short-circuit current.

The same also applies to motor circuit breakers. In the case of motor circuit breakers, however, the contact point is replaced by a twin contact point, two fixed contact pieces being provided which are bridged by a contact link. In the event of a short circuit, the contact link is brought into the open position by the electromagnetic release and at the same time the latching point is released; as a result of an overcurrent, the bending-out of a thermal release is used for opening the latching point, as in the case of line circuit breakers.

Residual current circuit breakers have the task of opening a contact point in the event of the occurrence of a residual current. Since the residual current is generally in the milli-ampere range, an electromagnetic release, as is conceived for a line circuit breaker, cannot be used at least in the case of tripping which is independent of the system voltage. The detection of a residual current takes place via a residual current transformer, the lines forming the primary winding. A secondary winding, which is connected to an electromagnetic release, is associated with the transformer. Such a release generally has a U-shaped yoke, whose limb ends are overlapped by a hinged armature, which is acted upon so as to move permanently in the switch-off direction by means of a spring. A permanent magnet is associated with the yoke, which permanent magnet produces a permanent magnetic flux in the yoke, by means of which the armature is held in a closed position, i.e. in a position in which the armature is resting on the yoke limb ends. By means of a coil which is associated with the yoke and which engages around one of the yoke limbs or the web, the voltage originating from the secondary winding of the transformer is converted into a magnetic flux, which is directed in the opposite direction to the magnetic flux produced by the permanent magnet. As a result, the attraction force to the armature is reduced and the armature is brought into the open position by the spring, as a result of which a latching mechanism is unlatched via a pin coupled to the armature, with the result that the switching contacts of the residual current circuit breaker are brought into the open position. The problem with such a release can consist in the fact that opening of the hinged armature is sometimes not possible because an adhesion process is possible on the yoke face, from which the armature is drawn away, as a result of environmental influences and other influences, with the result that a residual current circuit breaker does not trip even in the event of the occurrence of a residual current. As a result of the sensitivity of such a release, it is also necessary to insert it into a housing, which needs to be sealed off from the surrounding environment. Nonetheless, it is not possible to prevent moisture or the like from entering the housing through the opening, through which the pin is passed to the outside. For this reason, all residual current circuit breaker manufacturers recommend testing the residual current by pressing a test button; by means of the test button a residual current is simulated which produces a tripping current in the secondary winding and in the coil associated with the magnetic release, with the result that the residual current circuit breaker is switched off.

Instead of such a permanent magnet release, a so-called holding magnet release can also be used. In the case of this holding magnet release, a yoke is provided which has a comparatively narrow section in which, on the occurrence of a residual current, the material enters saturation, with the result that the armature can be drawn away from the yoke by means of a spring.

In any case, the embodiment of such an electromagnetic release is very complex.

Electrical switching devices which only switch on and off are referred to as contactors, which usually have a U-shaped or E-shaped magnet core, with which an armature is associated, a winding being associated with the yoke, which winding attracts the armature when an electrical current is passed through or causes the armature to drop, as a result of which a contact point can be opened or closed. In general, in the case of these contactors twin contact points are provided, which are each bridged by a contact link.

All types of drive are in principle completely different, the only similarities being with a line circuit breaker and a motor circuit breaker. A release for a residual current circuit breaker, however, is suitable neither for a contactor nor for a line circuit breaker; conversely, an electromagnetic release, which can be accommodated in a line circuit breaker, is unsuitable for a residual current circuit breaker at least when the release is intended to respond independently of the system voltage.

### SUMMARY

Exemplary embodiments disclosed herein can provide a release which can be used for all types of such switching devices, in which case the basic construction should be the same and modifications can only be carried out so as to match the current level.

An electrical switching device is disclosed with at least one contact point with at least one drive, which opens the contact point directly and/or via a switching mechanism with a latching point, wherein the drive has an element with a predetermined shape, which comprises a shape memory alloy which changes its shape under the influence of an electromagnetic field and in the process opens or closes a contact point or twin contact point or unlatches a switching mechanism.

The electrical switching device is disclosed, wherein the element changes its length or is twisted.

An electrical switching device is disclosed which can be switched on and off remotely by means of an electrical pulse, wherein the element, which changes its shape under the influence of an electromagnetic field as a result of a current surge, for the switching-off or switching-on operation, acts on a contact lever and/or on the switching handle likewise so as to switch it on and off.

In another aspect, an electrical switching device is disclosed, comprising at least one contact point, the at least one contact point being capable of being opened directly and/or via a switching mechanism with a latching point; and a drive having a shaped element which opens or closes said at least one contact point, wherein the element is formed of a shape memory alloy capable of changing its shape under the influence of an electromagnetic field.

### BRIEF DESCRIPTION OF THE DRAWINGS

The disclosure and further advantageous configurations and improvements and further advantages will be explained and described in more detail with reference to the drawing, in which a few exemplary embodiments of the disclosure are illustrated and in which:

FIG. 1 shows an exemplary switching device in a schematic illustration in the switched-on position,

FIG. 2 shows the switching device shown in FIG. 1 in the switched-off state,

FIG. 3 shows a schematic illustration of an exemplary residual current circuit breaker,

FIG. 4 shows a schematic illustration of a contactor in the switched-on position,

FIG. 5 shows an exemplary remote drive for an electrical switching device, and

FIG. 6 shows a remote drive in accordance with a further exemplary embodiment of the disclosure.

### DETAILED DESCRIPTION

According to the disclosure, an exemplary actuator comprises an element with a predetermined length, which comprises a shape memory alloy which changes its length under the influence of an electromagnetic field.

In this case, the element can be positioned in the direct vicinity of a device which produces an electromagnetic field, with the result that this field influences the element.

In another exemplary configuration, the device can be a coil, which surrounds the element, which is in the form of an elongate spindle.

WO 98/08261 has disclosed such shape memory alloys; see pages 2-5, end of 2nd paragraph, which is incorporated by reference. This document also states at which electrical field intensity the material responds; initially no mention is made of any applications.

A further document, which describes such shape memory alloys has been published under the number WO 99/45631, which is incorporated by reference.

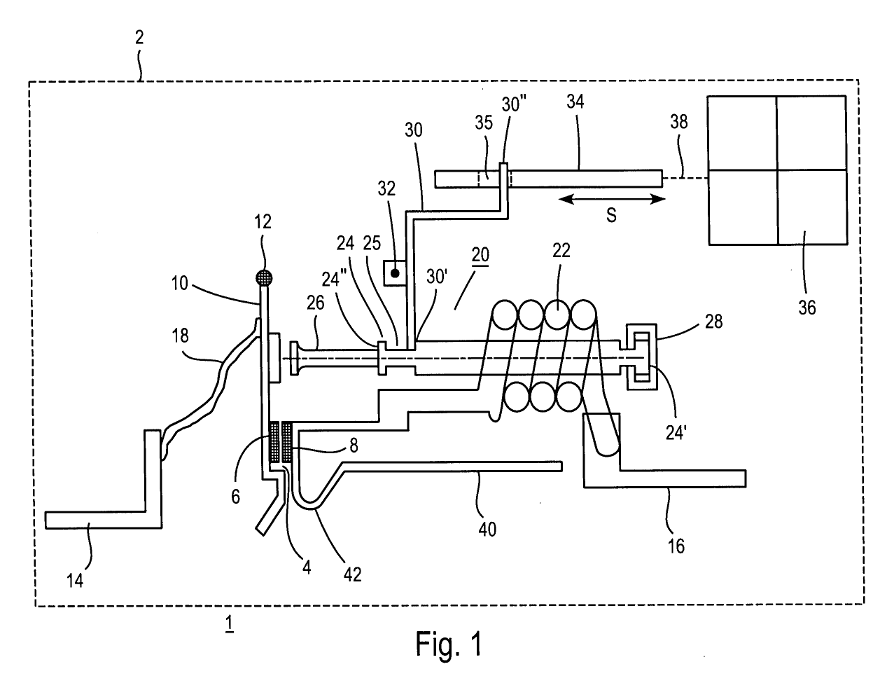

Reference is made to FIG. 1.

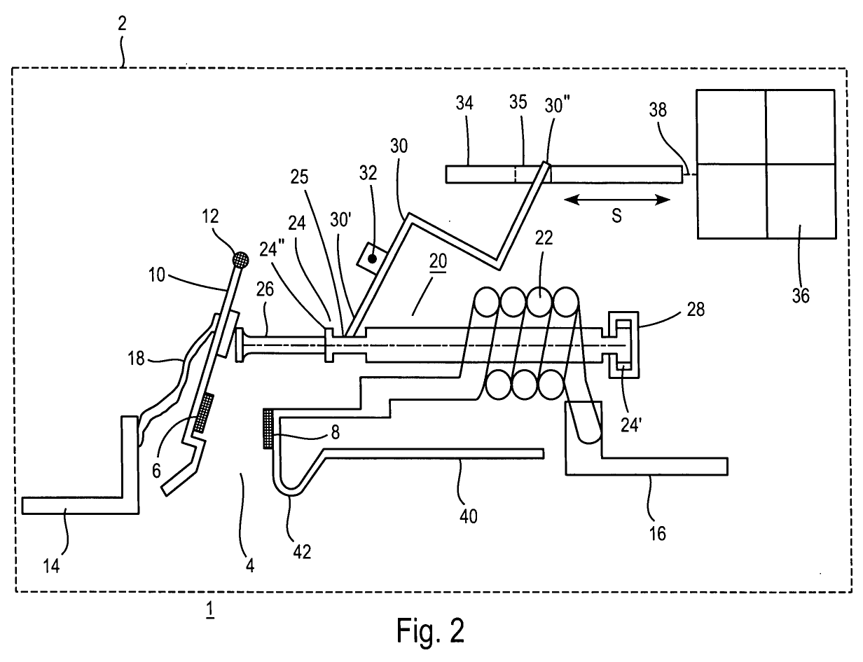

FIG. 1 shows, schematically, an exemplary switching device 1 with a housing 2, an electromagnetic release 20 and a switching mechanism 36 in the untripped state. FIG. 2 shows the switching device shown in FIG. 1 in the tripped state, identical or similarly functioning assemblies or parts being designated by the same reference numerals. A current path runs between an input clamping piece 14 and an output clamping piece 16 via a movable litz wire 18, a contact lever 10, which is mounted in a contact lever bearing 12, a contact point 4, which comprises a movable contact piece 6, which is located on the contact lever 10, and a fixed contact piece 8, and a tripping coil 22. In the switching position shown in FIG. 1, the contact point 4 is closed. A yoke 40 is also connected to the tripping coil 22 and the fixed contact piece 8 via a lug-shaped intermediate piece 42.

A thermal release, which is in addition still contained in some switching devices and acts on the switching mechanism in the event of the occurrence of an overcurrent, with the result that said switching mechanism then opens the contact point permanently, is not illustrated.

The electromagnetic release 20 comprises the tripping coil 22 and a tripping armature 24, which in this case is in the form of a bar and is arranged in the interior of the tripping coil 22 in such a way that the coil longitudinal axis and the tripping armature longitudinal axis coincide.

At a first, fixed end 24′, the tripping armature 24 is held in a tripping armature bearing 28, which is connected to the housing 2. At its second, free end 24″, the tripping armature 24 is operatively connected to a plunger 26. The operative connection is in this case shown as an interlocking connection, but force-fitting or cohesive connections could also be realized as an alternative.

At its free end 24″, the tripping armature 24 has a notch 25 into which a tripping lever 30, which is mounted in a tripping lever bearing 32, engages, for example with a fork located at its first free end 30′. The second free end 30″ of the tripping lever 30 engages in a cutout 35 in a slide 34, which is operatively connected to the switching mechanism 36 via a line of action 38.

The tripping armature 24 comprises a ferromagnetic shape memory alloy based on nickel, manganese and gallium. Such ferromagnetic shape memory alloys are known in principle and are available; they are manufactured and marketed, for example, by the Finnish company AdaptaMat Ltd. A typical composition of ferromagnetic shape memory alloys for the use according to the disclosure in switching devices is provided by the structural formula Ni_{65-x-y}Mn₂₀₊ₓGa_{15+y}, where x is between 3 atomic percent and 15 atomic percent and y is between 3 atomic percent and 12 atomic percent. The ferromagnetic shape memory alloy used here has the property that, in its martensitic phase, which is the phase which the material assumes below the thermal transition temperature, a transition between two crystal structure variants of a twin crystal structure takes place under the effect of an external magnetic field on a microscopic scale, which transition is macroscopically connected to a change in shape. In the embodiment of the tripping armature selected here, the change in shape consists in a linear expansion in the direction of the bar longitudinal axis.

The thermal transition temperature in the case of the ferromagnetic shape memory alloys used here is in the region of room temperature and can be adjusted by varying the atomic percent contents of x and y within a bandwidth. The working temperature range within which the electromagnetic release functions can therefore be adjusted within a bandwidth by selecting the material composition.

If a high short-circuit current is flowing through the switching device 2 in the event of a short circuit, the tripping armature 24 as a result of the abovedescribed effect expands, and as a result the plunger 26 strikes the movable contact piece 6 so as to move it away from the fixed contact piece 8, with the result that the contact point 4 is opened and the switching device is tripped, as illustrated in FIG. 2. The expansion of the ferromagnetic shape memory material in this case takes place very rapidly and virtually without any delay. The delay time as the time difference between the occurrence of the short-circuit current and the maximum length expansion of the tripping armature 24 is typically of the order of magnitude of 1 millisecond.

The tripping process is in this case assisted by the tripping lever 30, which rotates in the clockwise direction around the tripping lever bearing 32 when the tripping armature 24 expands and, in the process, displaces the slide 34 in its direction of longitudinal extent, indicated by the direction arrow S, with the result that the slide 34 actuates the switching mechanism 36 via the line of action 38.

Once the switching device has been tripped, the current path is interrupted and the magnetic field of the tripping coil 22 collapses again. As a result, the tripping armature 24 will contract to its initial dimensions again, as a result of which the tripping lever 30 is also moved back into the initial position again, as shown in FIG. 1. The contact point 4 is now held permanently in the open position through lines of action (not illustrated here) by means of the switching mechanism 36.

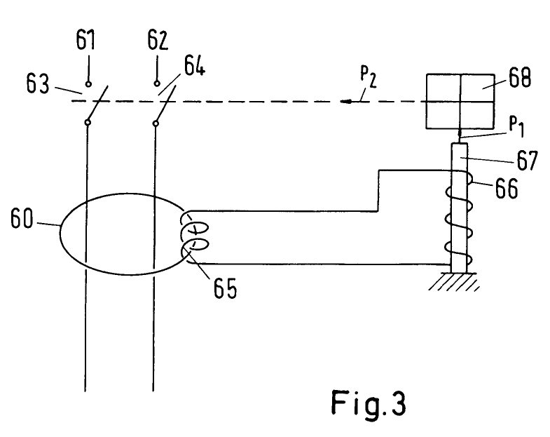

FIG. 3 shows an exemplary residual current circuit breaker in a schematic illustration.

A schematic illustration of this arrangement can be seen in FIG. 13. Primary conductors 61 and 62, which have contact points 63 and 64, are passed through a transformer core 60. A secondary winding 65 is arranged around the transformer core 60, which secondary winding 65 is connected to a coil 66, in which a plunger 67 made of a material with a magnetic, but possibly also with a magnetic and thermal shape memory effect passes through. This plunger 67 acts on a switching mechanism 68 in the arrow direction P1 and, after the unlatching process, the switching mechanism acts on the contact points 63, 64 corresponding to the arrow direction P2. In comparison with the arrangement shown in FIG. 1, the plunger 67 in FIG. 1 has the reference numeral 24; the switching mechanism 68 in FIG. 1 has the reference numeral 36, the coil 66 in the arrangement shown in FIG. 1 has the reference numeral 22 and, as can be seen, a plunger element 26 is missing because direct action on the contact points 63, 64 in the case of such a residual current circuit breaker is not conventional.

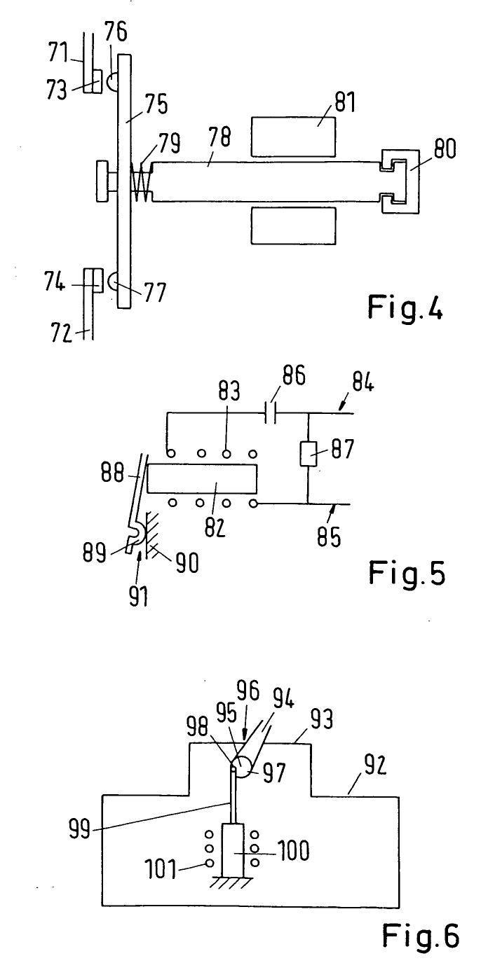

Reference is now made to FIG. 4.

FIG. 4 shows a contactor or parts of a contactor 70 with two fixed contact pieces 73 and 74, which are arranged at a distance from one another, are arranged on contact carriers 71 and 72 and are bridged by a contact link 75, on which movable contact pieces 76, 77 are fitted. FIG. 4 shows the contactor 70 in the switched-on state when the contact pieces 73, 76; 74, 77 are in touching contact with one another.

A plunger 78 made of a material with a magnetic shape memory effect, which is in the form of an elongate plunger whose one end is connected to the contact link 75 via a contact current spring 79 and whose other end is held fixed in position in a mount 80, which is fixed in a housing, is coupled to the contact link.

The plunger 78 is surrounded by an electromagnet system 81.

If the switch is now intended to be opened, the material of the plunger deforms with the electromagnetic shape memory effect; it is naturally also possible in the normal state, i.e. in the unstressed state, for the plunger 78 to be arranged in such a way that the contact points 73/76; 74/77 are open. As a result of a control current, the plunger will then expand owing to the magnetic field produced by the coil 81 as a result of the magnetic shape memory effect and will close the contact points, the contact compression spring 79 conventionally being compressed slightly during the switch-on process.

In the exemplary embodiment shown in FIG. 5, a plunger 82 made of a material with a magnetic shape memory effect is surrounded by a coil 83, the coil 83 being supplied with current via feed lines 84 and 85 via a high-pass filter, which is formed from a capacitor 86 and a resistor 87. If the plunger 82 expands as a result of the magnetic field, it actuates a contact lever 88 and opens a contact point 91, which is formed from a contact piece 89, which is fitted on a movable contact lever 88, and a fixed contact piece 90.

FIG. 6 shows a view into an exemplary line circuit breaker, only the parts which are important to the disclosure being illustrated.

The line circuit breaker overall has the reference numeral 92 with a front face 93, from which the switching handle 94 of a toggle switch 96, which is mounted rotatably at 95, protrudes. The switching handle 94 is integrally formed on a rotatable hub 97. At 98, a plunger 99 is articulated on the hub 97, which plunger 99 is coupled to an elongate element 100 made of a material with a magnetic shape memory effect. The element 100 is surrounded by a coil 101 and, when a current flows through, the length of the element 100 changes, with the result that the plunger 99 actuates the hub 97 and therefore the switching handle 94. Since the switching handle is conventionally linked and connected to the switching mechanism in the case of a line circuit breaker, in this way the switching device is switched on via the element 100 with the plunger 99.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electrical switching device with at least one contact point with at least one drive, which opens the contact point directly and/or via a switching mechanism with a latching point, wherein the drive has an element with a predetermined shape, which comprises a shape memory alloy which changes its shape under the influence of an electromagnetic field and in the process opens or closes a contact point or twin contact point or unlatches a switching mechanism.

2. The electrical switching device as claimed in claim 1, wherein the element is positioned in the direct vicinity of a device which produces an electromagnetic field, with the result that the field influences the element.

3. The electrical switching device as claimed in claim 2, wherein the device is a coil, which surrounds the element, which is in the form of an elongate spindle.

4. The electrical switching device as claimed in claim 1, wherein the element changes its length or is twisted.

5. The electrical switching device as claimed in claim 1, with a switching mechanism, a movable contact lever with a movable contact piece, which interacts with a fixed contact piece, wherein the element changes its shape under the influence of an electromagnetic field produced by a short circuit.

6. The electrical switching device as claimed in claim 1, wherein the element changes its shape under the influence of an electromagnetic field produced by a residual current.

7. The electrical switching device as claimed in claim 1, wherein the element is part of a contactor, which changes its shape under the influence of an electromagnetic field produced by a current surge.

8. An electrical switching device which can be switched on and off remotely by means of an electrical pulse, wherein an element, which changes its shape under the influence of an electromagnetic field as a result of a current surge, for the switching-off or switching-on operation, acts on a contact lever and/or on the switching handle likewise so as to switch it on and off.

9. The electrical switching device as claimed in claim 4, with a switching mechanism, a movable contact lever with a movable contact piece, which interacts with a fixed contact piece, wherein the element changes its shape under the influence of an electromagnetic field produced by a short circuit.

10. The electrical switching device as claimed in claim 4, wherein the element changes its shape under the influence of an electromagnetic field produced by a residual current.

11. The electrical switching device as claimed in claim 4, wherein the element is part of a contactor, which changes its shape under the influence of an electromagnetic field produced by a current surge.

12. An electrical switching device, comprising:
at least one contact point, the at least one contact point being capable of being opened directly and/or via a switching mechanism with a latching point; and
at least one drive, said at least one drive having a shaped element which opens or closes said at least one contact point, wherein the element is formed of a shape memory alloy capable of changing its shape under the influence of an electromagnetic field.

13. The electrical switching device as claimed in claim 12, wherein said at least one contact point is at least one of a contact point, double contact point, and a switching mechanism.
